(19) United States
(12) Patent Application Publication
(10) Pub. No.: US 2012/0233160 A1
(43) Pub. Date: Sep. 13, 2012

(54) SYSTEM AND METHOD FOR ASSISTING A USER TO IDENTIFY THE CONTEXTS OF SEARCH RESULTS

(75) Inventors: GEORGE PAULOSE KOOMULLIL, BANGALORE (IN); HARIHARAN RAMASANGU, BANGALORE (IN); AMRITA LAKSHMI, BANGALORE (IN); NIKHIL CHHAOCHHARIA, BANGALORE (IN)

(73) Assignee: INDUS TECHINNOVATIONS LLP, BANGALORE (IN)

(21) Appl. No.: 13/252,581

(22) Filed: Oct. 4, 2011

(30) Foreign Application Priority Data
Mar. 7, 2011 (IN) 666/CHE/2011

(51) Int. Cl. G06F 17/30

(52) U.S. Cl. 707/728; 707/722; 707/E17.008; 707/E17.018; 707/E17.014

(57) ABSTRACT

The present invention provides a method and a system of providing assistance to a user to identify at least one context of a received content. In one embodiment, this is accomplished by receiving at least one content location as input from the user, extracting the content from the received content location and displaying a plurality of contexts relevant to the content from the received content location, wherein the contexts include one or more topics, and wherein the topics are part of one or more ontologies. In second embodiment, this is accomplished by receiving at least one search result of a search query and providing the contexts relevant to the search results, wherein the contexts include one or more topics, and wherein the topics are part of one or more ontologies.

### CROSS-REFERENCES TO RELATED APPLICATIONS

The present application claims priority from the Indian (IN) provisional patent application serial no. 3028/CHE/2010 filed on Oct. 13, 2010 and entitled “A system and method for assisting the user to select the context of a search and to display the contexts of search results” the content of which is herein incorporated by reference in its entirety.

### FIELD OF THE INVENTION

The invention relates generally to network and internet search. More particularly, to a method and a system for providing assistance to a user to identify one or more contexts of an input or search results.

### BACKGROUND OF THE INVENTION

Search services are currently being improved to increase users' convenience. Accordingly, when a user inputs an appropriate query, the search service must provide satisfactory search results. Specifically, as users of search service are being expanded and also users who do not have enough background knowledge about appropriate queries increase, it is required to guide the users to make an appropriate query or refine the query from the search results.

The amount of data available on various topics has been increasing drastically over the years, internally in companies and externally in the internet. The most common way of retrieving relevant information is through filters or keyword based queries. One problem with the present approach is that the amount of information shows up in any query is very large and it is time consuming to sort the information to determine the most relevant information. This problem is aggravated by the fact that users themselves do not know the right keywords or contexts to be used in the search even if the user has clear ideas about the type of knowledge the user is looking for.

In another case, the user does not have sufficient knowledge on the area of search and needs guidance in navigating through relevant topics within the subject. This is the case where the user does not know what to look for but still expects relevant information to be provided by the system.

There have been major improvements in providing relevant information for each user based on the contexts derived from the data collected explicitly from the user or implicitly through user's implicit feedback through key strokes, historical selections or other behavioural patterns of the user. As a result the results received from major search engines such as Google, Yahoo, and Bing etc. retrieve information relevant to the query in most cases. However, these search engines are still limited by the fact that the users need to spend long periods of time to receive the intended information. The user can only alter the search query to retrieve the relevant information. There is no guided way available for the user to refine the context of the search results.

There are two major factors for not receiving the intended information from a search. One is that the user is unable to provide sufficient details of the intended information to the search engine. In most cases the input is a number of query terms and the search engine is expected to bring the intended information from the search. First of all, the terms input to the system may not be accurate enough to address the intended information. In addition, the list of a few terms is not sufficient to accurately communicate the intended information to the system.

The second factor that limits the retrieval of intended information from a search is that the search engine does not provide sufficient information about the results that would help the user to select the intended information. Current search engines provide the URL of the retrieved files and representative text or image from the file. These are not sufficient to select the intended information from the list of search results.

For the reasons stated above, which will become apparent to those skilled in the art upon reading and understanding the present specification, there is a need in the art for to a method and a system for providing assistance to a user to identify one or more contexts of an input or search results.

### SUMMARY OF THE INVENTION

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

According to one aspect of the invention there is provided a method of providing assistance to a user to identify at least one context of search results of a search query, the method comprising: receiving an input related to the search query, providing a plurality of first contexts related to the received input, wherein the first contexts include one of the keywords and concepts, displaying a set of results from a web search or a file search based on the selection of the first context, each search result containing a link to a web page or file location and displaying a plurality of second contexts relevant to the search results, wherein the second contexts include one or more topics, and wherein the topics are part of one or more ontologies.

In another aspect of the invention there is provided a method of providing assistance to a user to identify at least one context of a content of at least one input, the method comprising: receiving content location as input from the user, extracting the content from the received content location, and displaying a plurality of contexts relevant to the content from the received content location, wherein the contexts include one or more topics, and wherein the topics are part of one or more ontologies.

According to another aspect of the invention there is provided a method of providing assistance to a user to identify at least one context of search results of a search query, the method comprising: receiving an input as a search query, displaying a set of results from a web search or a file search, each search result containing a link to a web page or file location and displaying a plurality of contexts relevant to the search results, wherein the contexts include one or more topics, and wherein the topics are part of one or more ontologies.

In another aspect, the invention includes a system of providing assistance to a user to identify one or more contexts of the search results of a search query, the system comprising: one or more communication networks, a plurality of user devices connected to the communication network and at least one server coupled to a data store, the server comprising a content extractor and a context module, wherein the server is capable of communicating with the plurality of user devices via at least one communication network, the server is configured for receiving an input as a search query, displaying a set of search results from a web search or a file search, each search result containing a link to a web page or file location and displaying a plurality of contexts related to the search results, wherein the contexts include one or more topics, and wherein the topics are part of one or more ontologies.

In another aspect, the invention provides a machine-readable medium having stored thereon machine-executable instructions that if executed by a machine cause the machine to perform a method of providing assistance to a user to identify one or more contexts of the search results of a search query, the method comprising: receiving an input as a search query, displaying a set of search results from a web search or a file search, each search result containing a link to a web page or file location and displaying a plurality of contexts related to the search results, wherein the contexts include one or more topics, and wherein the topics are part of one or more ontologies.

In another aspect, the invention provides a machine-readable medium having stored thereon machine-executable instructions that if executed by a machine cause the machine to perform a method of providing assistance to a user to identify one or more contexts of the search results of a search query, the method comprising: receiving an input as a search query, displaying a set of search results from a web search or a file search, each search result containing a link to a web page or file location, displaying a plurality of contexts related to the search results, wherein the contexts include one or more topics, and wherein the topics are part of one or more ontologies, and allowing the user to navigate to select at least one of the topics to retrieve a different context of search results, wherein the displayed search results are related to the selected topics.

Additional advantages and features of the present invention will be more apparent from the detailed description and accompanying drawings, which illustrate preferred embodiments of the invention.

### BRIEF DESCRIPTION OF THE DRAWINGS

FIG. 1 shows a first aspect of an exemplary user interface to identify at least one context of search results of a search query according to one embodiment of the present invention.

FIG. 2 shows a second aspect of an exemplary user interface to identify at least one context of search results of a search query according to one embodiment of the present invention.

FIG. 3 shows a third aspect of an exemplary user interface to identify at least one context of search results of a search query according to one embodiment of the present invention.

FIG. 4 shows an exemplary user interface showing one or more contexts of search results of a search query according to one embodiment of the present invention.

FIG. 5 shows another exemplary user interface identify one or more contexts of a received content as input according to one embodiment of the present invention.

FIG. 6 illustrates an example method of providing assistance to a user to identify at least one context of search results of a search query according to an exemplary embodiment of the present invention.

FIG. 7 illustrates an example method of providing assistance to a user to identify one or more contexts of a received content as input according to an exemplary embodiment of the present invention.

FIG. 8 illustrates an example method of providing assistance to a user to identify at least one context of search results of a search query according to an exemplary embodiment of the present invention.

FIG. 9 illustrates a system of providing assistance to a user to identify at least one context of search results of a search query according to an exemplary embodiment of the present invention.

FIG. 10 illustrates an example of a suitable computing environment of the method as described in FIGS. 6, 7 and 8 that may be fully or partially implemented.

### DETAILED DESCRIPTION OF THE INVENTION

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in demonstrative embodiments,” “in some embodiment,” “in other embodiments,” or similar language throughout this specification do not necessarily all refer to the same group of embodiments and the described features, structures, or characteristics may be combined in any suitable manner in one or more embodiments.

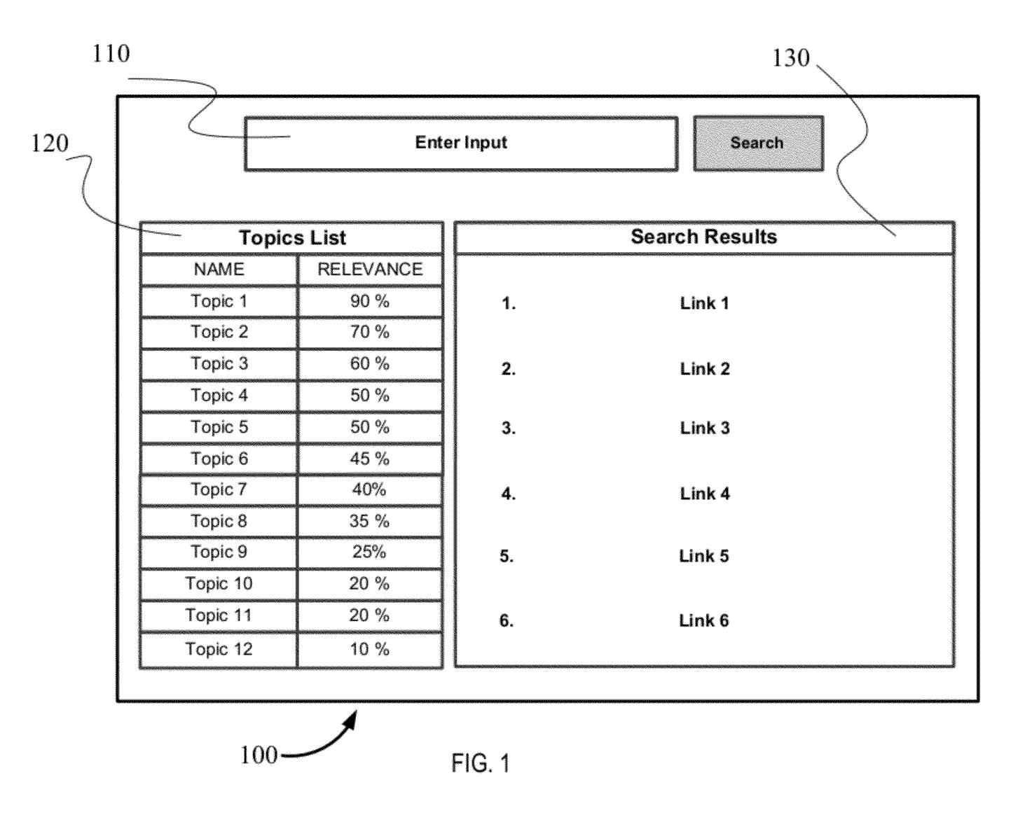

FIG. 1 shows a first aspect of an exemplary user interface to identify at least one context of search results of a search query according to one embodiment of the present invention. FIG. 1 illustrates a User Interface 100 includes query window 110, a topic window 120 and a search results window 130. The query window is capable of accepting one or more query strings or query sequences from one or more users. The search results window 130 is capable of displaying or generating search results related to the received query string or query sequence. As soon as the system displays search results in the search results window 130, the topic window 120 is capable of generating or displaying contexts related to the displayed search results in the search results window 130. In other aspects of the present invention, the system is capable of generating relevant results which may be the search result of the input query by the user without even clicking the search button. The context may be or may include topics and topic relation, where the topics and topic relations are based on underlying domain ontologies which are related to the search results. The domain may include a subject matter topic such as, for example, a disease, an organism, a drug, or other topic. The domain may also include one or more entities such as, for example, a person or group of people, a corporation, a governmental entity, or other entities. The domain involving an organization may focus on the organization's activities. For example, a pharmaceutical company may produce numerous drugs or focus on treating numerous diseases. The ontology built on the domain of that pharmaceutical company may include information on the company's drugs, their target diseases, or both. The domain may also include an entire industry such as, for example, automobile production, pharmaceuticals, legal services, or other industries. Other types of domains may be used.

In an example, the system displays a plurality of contexts related to the search results, where the contexts may be or may include topics and topic relations. Once the topics are displayed in the topic window 120, the user is allowed to select topic or topics. After the selection of topic or topics, where the selected topic or topics are the intended information of the user, the user is allowed to tick the search button to get the preferred results. In addition, the topics are shown with respect to the relevancy ranking in a descending order or it may be in an ascending order which is based on user preference.

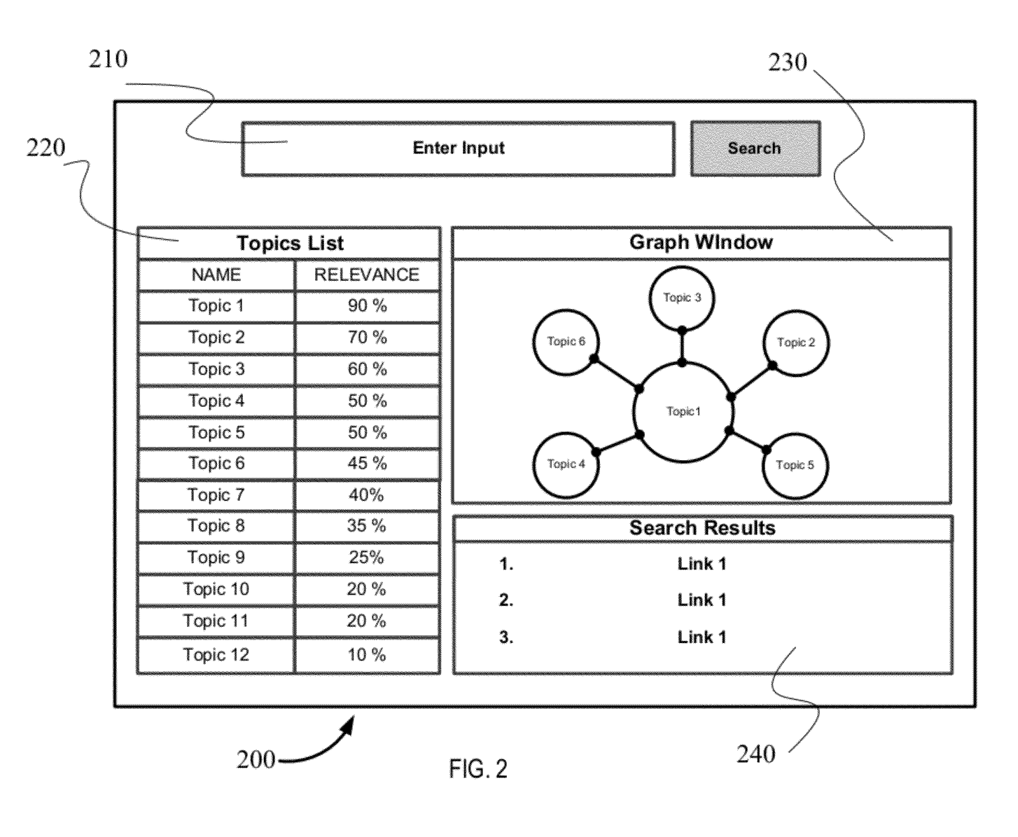

FIG. 2 shows a second aspect of an exemplary user interface to identify at least one context of search results of a search query according to one embodiment of the present invention. FIG. 2 illustrates a User Interface includes query window 210, topic window 220, a graph window 230 and a search results window 240. The query window is capable of accepting one or more query strings or query sequences from one or more users. The search results window 240 is capable of displaying or generating search results related to the received query string or query sequence. In addition to this, the system is capable of generating or displaying contexts in the topic window 220 related in respect of the generated or displayed search results in the search window 240. Also, the system is capable of representing the relation between the topic or topics or/and their semantic proximity of one topic in a graphical representation in a graph window 230. The graphical representation of the topic or topics or/and their semantic proximity of one topic are also a part of the underlying ontology.

Further, the graphical representation in the graph window of the topic or topics or/and semantic proximity of the topic and their relations allows the user to navigate to retrieve his actual search result which the user is looking for. In addition of all, the plurality of contexts and their relation are shown with the relevancy ranking with respect to the entered query by the user. In one example embodiment, the graphical representation is shown in a topology having a context and all sub-contexts are connected to the context. The connection between all the other nodes with respect to root node is directly descending from the root node. The root node shown in the graphical representation has the highest relevancy rank and other nodes are descendents of the main root node.

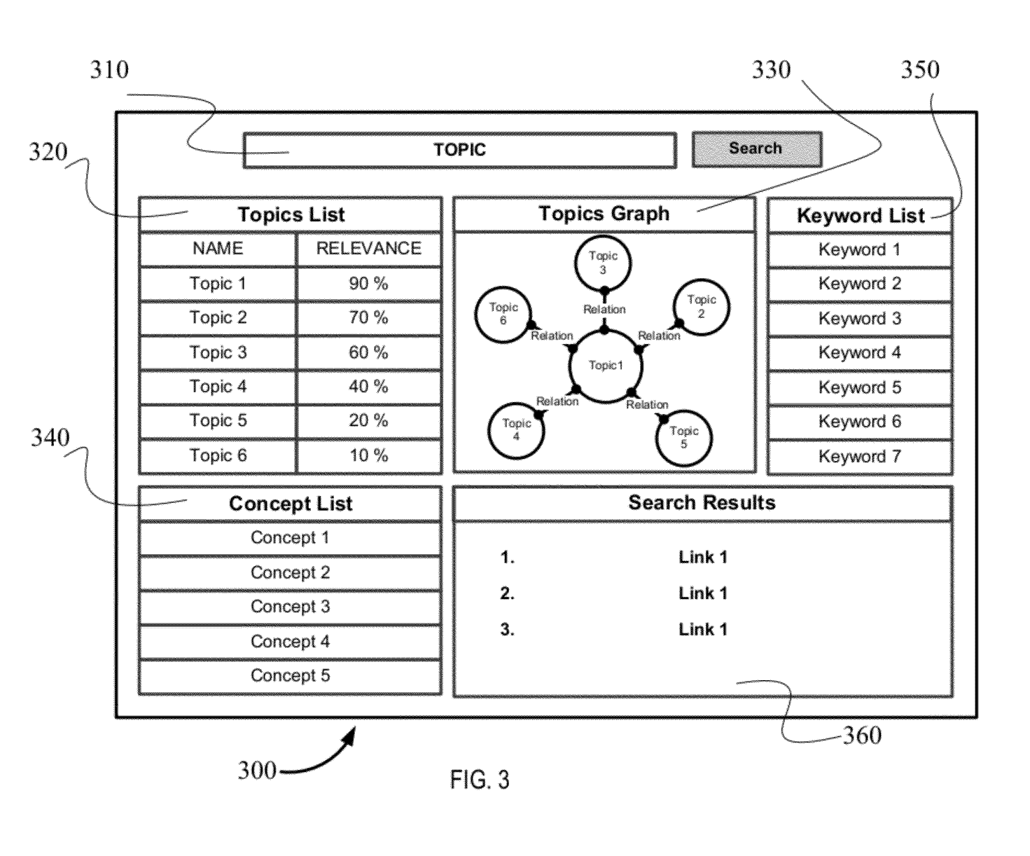

FIG. 3 shows a third aspect of an exemplary user interface to identify at least one context of search results of a search query according to one embodiment of the present invention. FIG. 3 illustrates the User Interface includes query window 310, a topic window 320, a graph window 330, a concepts window 340, a keyword window 350 and a search results window 360. The query window 310 is capable of accepting one or more query strings or query sequences from one or more users. The search results window 360 is capable of displaying or generating search results related to the received query string or query sequence. In addition to this, the system is capable of generating or displaying contexts in the topic window 320 related in respect of the generated or displayed search results in the search window 360. Also, the system is capable of representing the relation between one or more topics and their semantic proximity in a graphical representation in a graph window 330. The representation of one or more topics and their semantic proximity are a part of the underlying ontology.

The topic window 320 is capable of displaying contexts related to the generated or displayed search results in the search results window 360. In other aspects of the present invention, the system is capable of generating relevant results which may be the search result of the input query by the user before clicking the search button after the input is received from the user at the search query window 310. Further, the system is capable of displaying or generating a plurality of contexts related to the generated or displayed search results in the search results window 360. The context may be or may include topics and topic relation, where the topics and topic relations are based on underlying domain ontologies. In the graph window 330, the displayed contexts in the topic window 320 are shown in a graphical representation which is also a part of the underlying ontology.

In addition of the above, the system is capable of generating one or more concepts and one or more keywords related to the generated or displayed search results. The concepts and keyword are displayed in their respective windows i.e. concept window 340 and keyword window 350. The displayed concepts are based on semantic proximity and the displayed keywords are based on the words available in the domain.

The system is capable of displaying all the windows simultaneously as soon as the query window receives one or more inputs. By displaying all the windows with different options, the user is capable of identifying at least one context of search results of a search query and their relationship, one or more concepts, and one or more keywords. The present system helps the user to take decision quickly and with an ease on the search results by avoiding unnecessary keep looking for the results displayed in the search results window 360. In addition to this, there is also possibility of having a provision for adding a keyword or a concept known to the user with the help of a tab (not shown in figures) or removing a keyword or a concept displayed by the system from their respective windows.

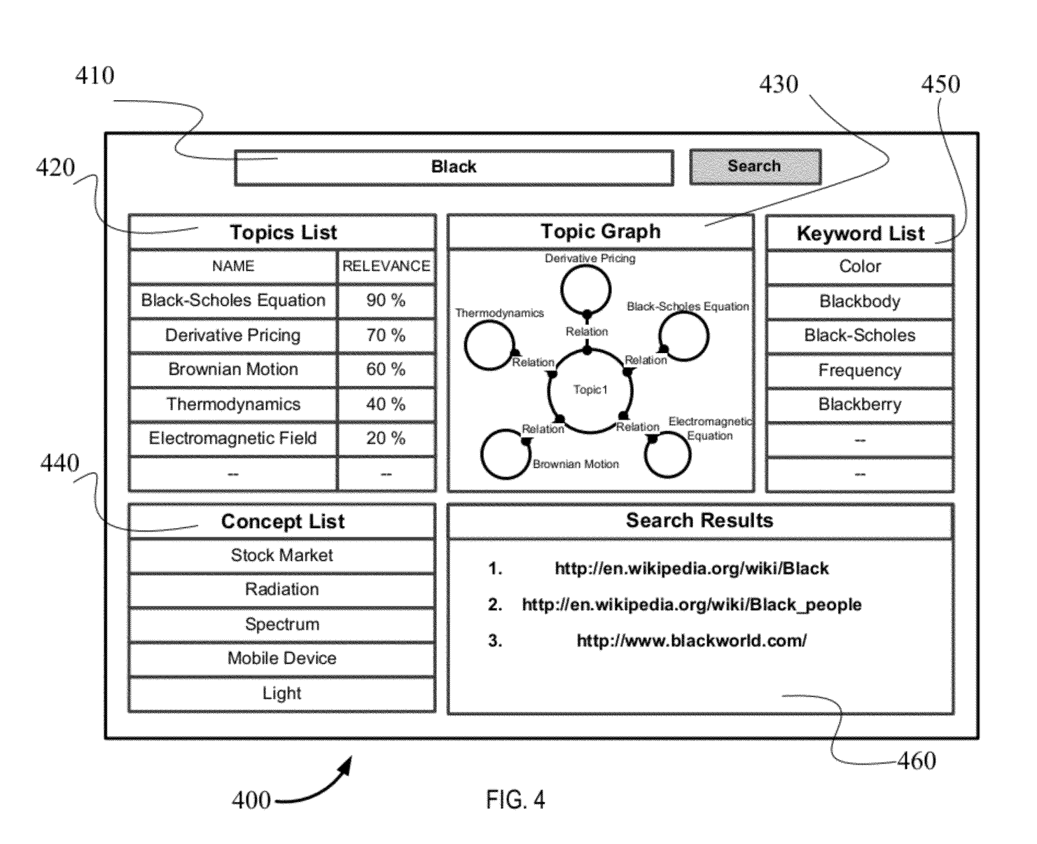

FIG. 4 shows an exemplary user interface showing one or more contexts of search results of a search query according to one embodiment of the present invention. FIG. 4 illustrates the User Interface includes query window 410, a topic window 420, a graph window 430, a concepts window 440, a keyword window 450 and a search results window 460. In one example embodiment, the query window is capable of accepting query string or query sequence (example: ‘Black’) from a user. The search results window 460 is capable of displaying or generating search results related to the received query string ‘Black’. The search results displayed are in the form of Uniform Resource Locators (URLs).

The system is capable of generating or displaying contexts in the topic window 420 related in respect of the generated or displayed search results in the search window 460. Also, the system is capable of representing the relation between the topic or topics or/and their semantic proximity of one topic in a graphical representation in a graph window 330. The graphical representation of the topic or topics or/and their semantic proximity of one topic are also a part of the underlying ontology. The topic window 420 displays a plurality of topics i.e. Black-Scholes Equation, Derivative Pricing, Brownian Motion, Thermodynamics, Electromagnetic Field, etc. All the displayed topics under the topic window 420 underlying domain ontologies which include topics and their relations in respect of search results of the search query i.e. ‘Black’. The first three topics belong to financial domain ontology and the last two belong to Physics Ontology. In the graph window 430, the displayed contexts in the topic window 420 i.e. topic and topic relation are shown in a graphical representation which is also a part of the underlying ontology as shown in FIG. 4. In an example display, the root node is a Black-Scholes Equation and all the branch nodes are Derivative Pricing, Brownian motion, Risk Analysis, and Parameter Estimation. The relations between the root node and the branch nodes discloses Black-Scholes Equation models uncertainty in the form of Brownian Motion, Black-Scholes Equation is used in Risk Analysis, Black-Scholes Equation whose solution gives Derivative Pricing, Black-Scholes Equation modeling involves Parameter Estimation etc.

In addition to these, the system generates one or more concepts and one or more keywords related to the generated or displayed search results of the search query ‘Black’. The concepts and keywords are displayed in their respective windows i.e. concept window 440 and keyword window 450. In an example, the concepts related to the search results of the query word ‘Black’ are stock market, radiation, spectrum, mobile device light etc. The displayed concepts are based on semantic proximity of the search results of the query word ‘Black’. The keywords related to the search results of the query are color, black body, black-scholes, frequency, blackberry etc. The displayed keywords are based on the words available in the domain.

The system by generating various options in the interface allows the user to choose or to select one or more contexts, one or more concepts, and one or more keywords of search results of a search query.

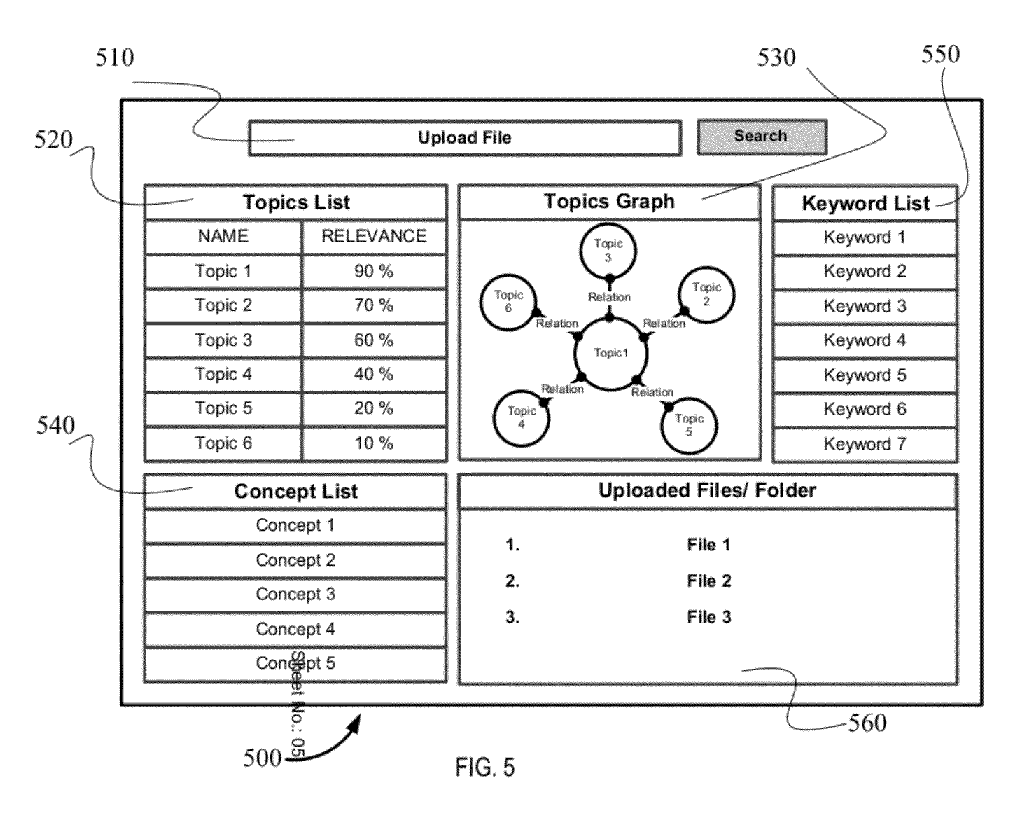

FIG. 5 shows another exemplary user interface identify one or more contexts of a received content as input according to one embodiment of the present invention. FIG. 5 illustrates the User Interface includes upload box window 510, a topic window 520, a graph window 530, a concepts window 540, a keyword window 550 and an uploaded file list window 560. The query window 510 is capable of accepting one or more files from one or more users.

The user is allowed to enter a file to upload in the upload box window 510. The uploaded files are displayed in the uploaded file list window 560. The contexts related to the uploaded file are displayed in the topic window 520 before clicking the search button. The context may be or may include topics and topic relation, where the topics and topic relations are based on underlying domain ontologies. In addition to this, the system is capable of representing the relation between the topic or topics or/and their semantic proximity of one topic in a graphical representation in a graph window 530. The graphical representation of the topic or topics or/and their semantic proximity of one topic are also a part of the underlying ontology.

In addition of the above, the system is capable of generating one or more concepts and one or more keywords related to the uploaded file. The concepts and keywords are displayed in their respective windows i.e. concept window 540 and keyword window 550. The displayed concepts are based on semantic proximity and the displayed keywords are based on the words available in the domain.

The keywords window 550 related to the content of the uploaded files are displayed along with a provision for removing a keyword (not shown in figure) from the context. In addition to this, it is also possible for adding keywords to the context in the keyword window 550. The concept window 540 displays concepts which are related to the content of the uploaded files along with a provision for removing a concept from the context. It is also possible for adding concepts using the concept window 540 to the context. The topics in the topic window 520 are related to the content of the uploaded files along with the corresponding relevancy factor to the content of the uploaded files. Every topic has an underlying ontology which includes multiple topics and their relations. In the graph window 530, the user is allowed to navigate in the graphical representation of the context or topic or topics relation. If the user clicks or selects one topic in the representation, the system takes the user to a different part of ontology, where the selected topic becomes the central theme. Also, one or more connected nodes along with root node are displayed where each connected node corresponding to at least one topic, wherein each connected node is connected to the root node, each of the connections corresponding to at least one relationship.

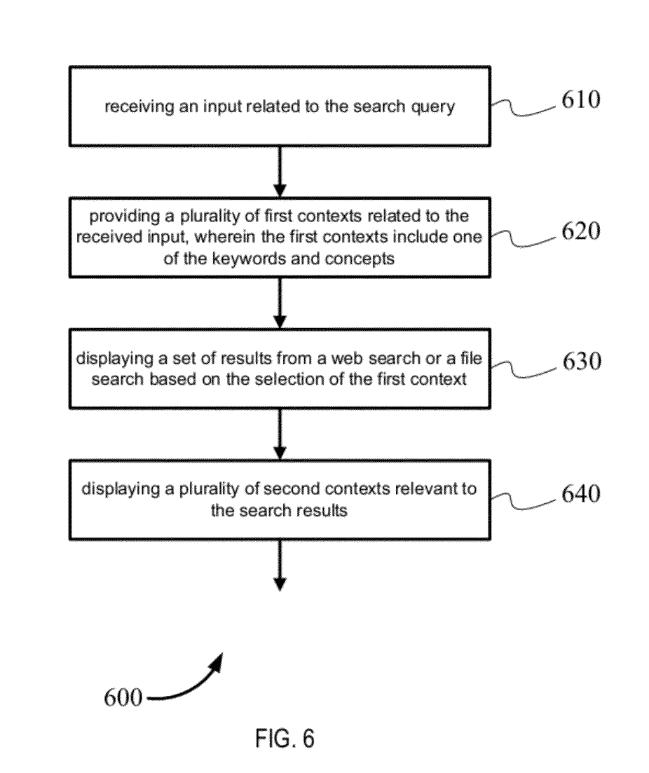

FIG. 6 illustrates an example method 600 of providing assistance to a user to identify at least one context of search results of a search query according to an exemplary embodiment of the present invention. In an operation, the method 600 at step 610 the method receives an input related to the search query. At step 620, the method provides a plurality of first contexts related to the received input. The first contexts may be or may include one of the keywords and concepts. At step 630, the method displays a set of results from a web search or a file search based on the selection of the first context. The search result contains a link to a web page or file location. At step 640 the method displays a plurality of second contexts relevant to the search results. The second contexts include one or more topics, and wherein the topics are part of one or more ontologies.

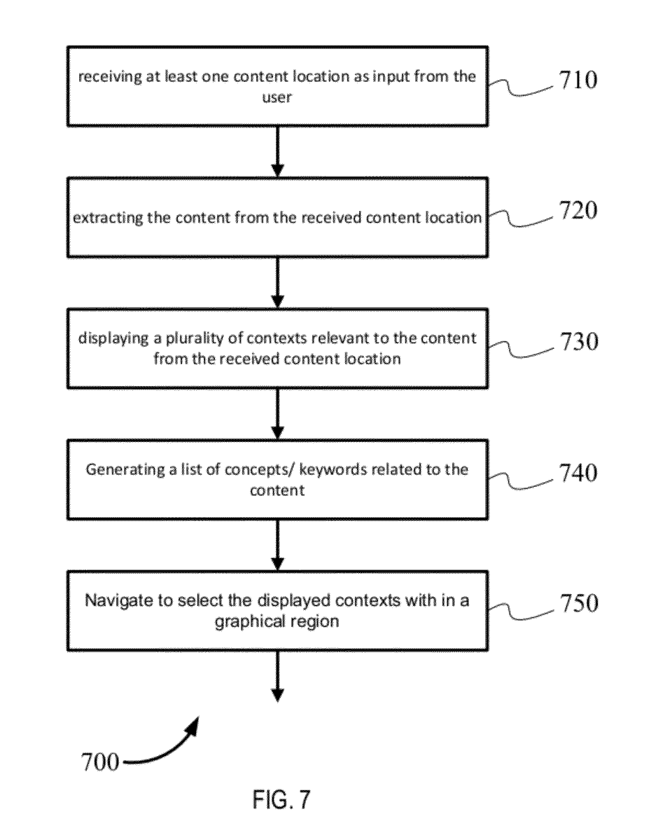

FIG. 7 illustrates an example method of providing assistance to a user to identify one or more contexts of a received content as input according to an exemplary embodiment of the present invention. In an operation, the method 700 at step 710 receives one or more content locations as input from one or more users, where the content location may be or may include a link to a file or a webpage containing the content and also a folder containing a content location. At step 720, the method extracts the content from the received content location entered by the user. At step 730, the method displays a plurality of contexts relevant to the content from the received content location, where the contexts include one or more topics, and wherein the topics are part of one or more ontologies. At step 740, the method generates a list of concepts and keywords related to the content. The generated concepts are based on semantic proximity and the generated keywords are based on the words available in the domain. At step 750, the method allows the user to navigate to select the displayed contexts with in a graphical region. The method is capable of representing the relation between the topic or topics or/and their semantic proximity of one topic in a graphical representation. The graphical representation of the topic or topics or/and their semantic proximity of one topic are also a part of the underlying ontology.

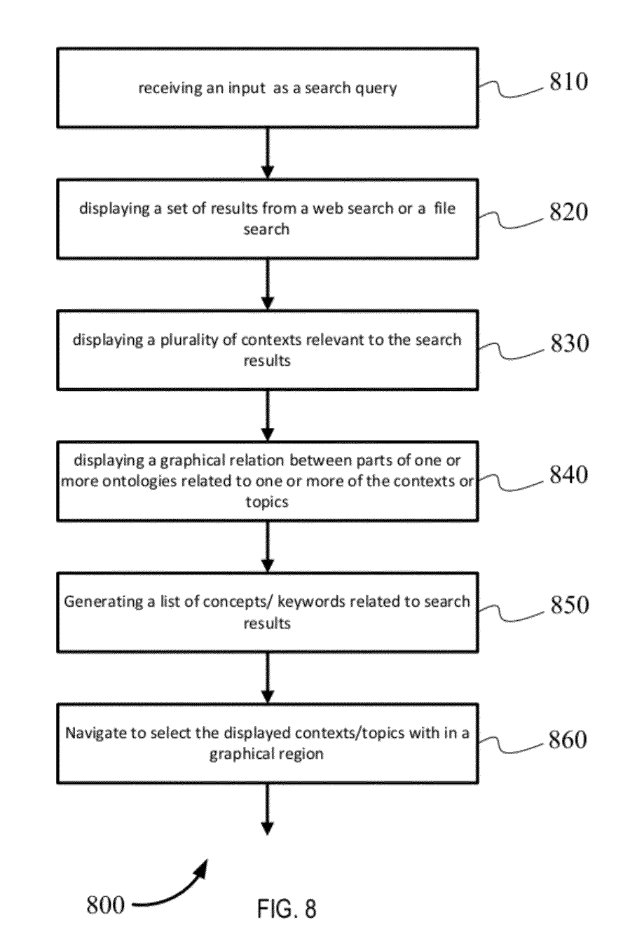

FIG. 8 illustrates an example method of providing assistance to a user to identify at least one context of search results of a search query according to an exemplary embodiment of the present invention. In an operation, the method 800 at step 810 receives an input as a search query, where the input is in the form of one or more terms, one or more documents, or one or more Uniform Resource Locator (URLs).

At step 820, the method displays a set of results from a web search or a file search, each search result containing a link to a web page or file location.

At step 830, the method displays or able to generate one or more contexts relevant to the search results. The contexts include one or more topics, and where the topics are part of one or more ontologies. The method displays one or more contexts based on the relevance ranking that matches the search results.

At step 840, the method displays in a graphical representation of a relation between parts of one or more ontologies related to one or more of the contexts or topics. The graphical representation of the topic or topics or/and their semantic proximity of one topic are also a part of the underlying ontology. The method displays a part of one or more ontologies related to one or more of the contexts in a two-dimensional or three-dimensional representation. The one or more ontologies include a plurality of assertions with each assertion including a first topic, a second topic and a relationship between the first topic and the second topic. The graphical representation includes a root node that depicts at least one topic and one or more connected nodes, each connected node or branch node corresponding to at least one topic, wherein each connected node is connected to the root node, each of the connections corresponding to at least one relationship.

At step 850, the method further generates a list of concepts and keywords related to search results. The displayed or generated concepts are based on semantic proximity and the displayed or generated keywords are based on the words available in the domain.

At step 860, the method allows the user to navigate to select the displayed contexts/topics with in a graphical region. By navigating in the region, the user made a first selection of any node, the method retrieves a part of ontology related to the first selected node and the first selected node becomes the root node. Further the user may make a second selection of any node that retrieves a set of documents related to the second selected node and displays in terms of web page URL or file location.

Although the flowcharts 600, 700 and 800 includes steps 610-640, 710-750 and 810-860 that are arranged serially in the exemplary embodiments, other embodiments of the subject matter may execute two or more steps in parallel, using multiple processors or a single processor organized as two or more virtual machines or sub-processors. Moreover, still other embodiments may implement the steps as two or more specific interconnected hardware modules with related control and data signals communicated between and through the modules, or as portions of an application-specific integrated circuit. Thus, the exemplary process flow diagrams are applicable to software, firmware, and/or hardware implementations.

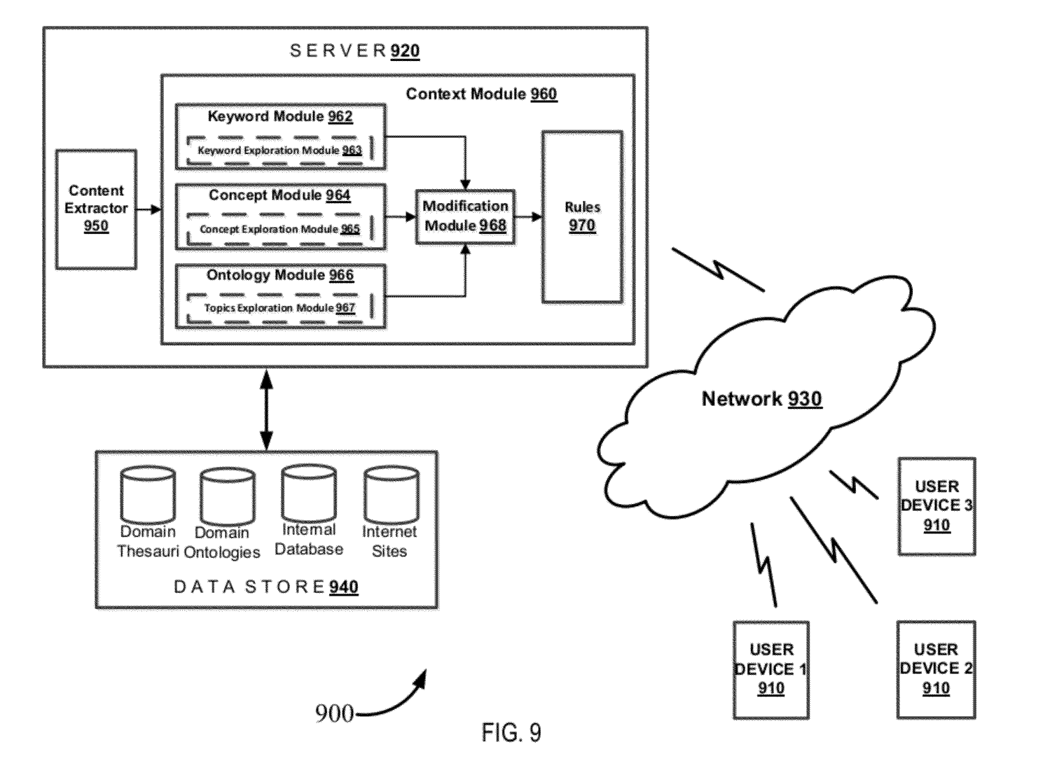

FIG. 9 illustrates a system of providing assistance to a user to identify at least one context of search results of a search query according to an exemplary embodiment of the present invention. The system 900 includes one or more user devices 910, one or more servers 920 and one or more communication networks 930. The user device 910 may be or may include personal computer, mobile device, laptop and the device like. The server 920 may be or may include, for example, a handheld device, a computing device, a computer, a mobile computer, a portable computer, a laptop computer, a handheld computer, a handheld device, a PDA device, a handheld PDA device, a mobile or portable device, or the like. According to some aspects, the server 920 may comprise an interface (not shown in figure) connectable to one of the other devices/network via a wired or wireless connection. The communication network 930 may be or may include one or more networks selected from a group of networks consisting of a local area network, a metropolitan area network, a wide area network, a ring network and the like.

The server 920 further includes or coupled to a data store 940. In one form of data store is a database designed to integrate data from multiple sources for additional operations on the data. The data store 940 may include but not limited to domain thesauri, domain ontology, internal database, and internet sites.

The server 920 further includes a content extractor 950 and a context module 960. The content module 960 further includes a keyword module 962, a concept module 964 and an ontology module 966. The content extractor 950 is capable of extracting the content from the received input from one or more user input devices 910 through a communication network 930. The received input may include but not limited to terms, documents or URLs etc. The context module 960 is capable of processing the received input from the content extractor 950, and further coupled to data store 940 to provide or generate keyword list, concept list, topics and their relations.

The keyword module 962 has a keyword exploration module 963 which is capable receiving the keyword list provided by the keyword module 962 as input and allows the user to navigate through other keywords related to one or more of the input keywords in the displayed graphical region. The concept module 964 has a concept exploration module 965 which is capable of receiving the concept list provided by the concepts module 964 as input and allows the user to navigate through other concepts related to one or more of the input concepts in the displayed graphical region. The ontology module 966 has a topic exploration module 967 which is capable of receiving the topics and relations lists provided by the ontology module 966 as input and allows the user to navigate through other topics related to one or more of the input topics in the displayed graphical region. All the outputs of three modules i.e. keyword exploration module, concepts module and the topic exploration module are further processed by the modification module 968 which receives as input as graphs of keywords, concepts and topics, and allows the user to select a set of keywords, concepts and topics from the displayed graphical regions. In addition to this, the modification module allows the user to add new keywords, concepts and topics.

The system 900 further includes a rules module 970 which defines the rules for the search. The rules can be specified and stored in the system or given as input by the user. Rules may be or may include specifying the proximity of two terms in the search, allotting different weightage for different fields in the extracted content etc.

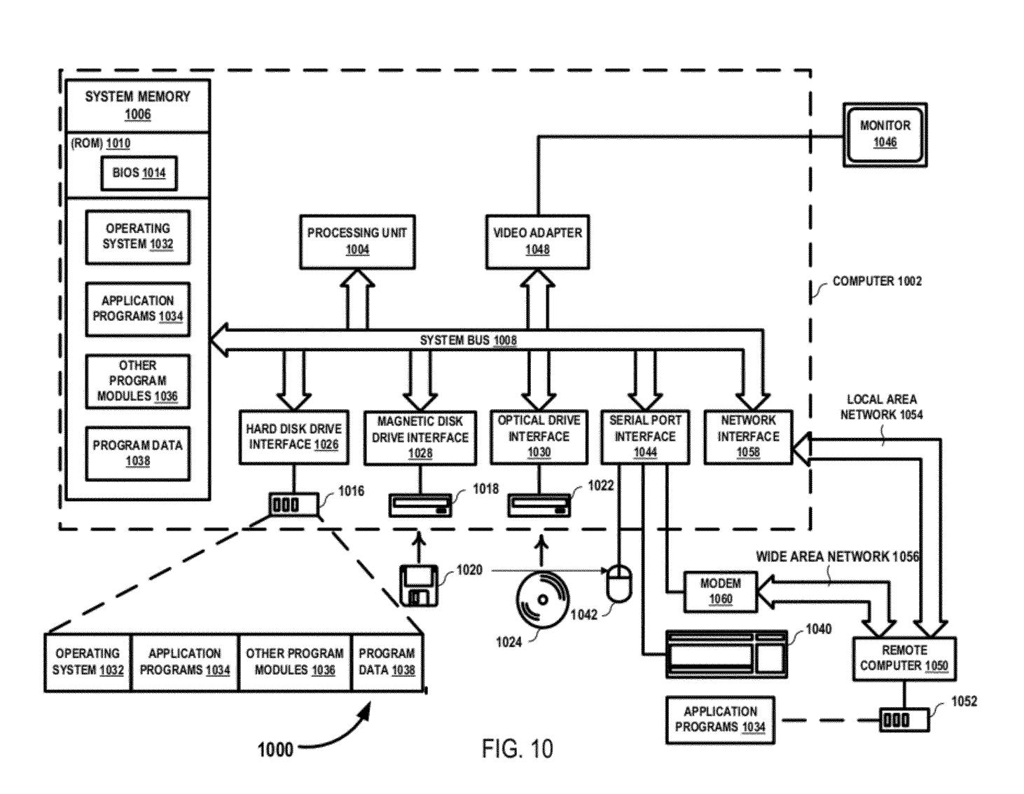

FIG. 10 illustrates an example of a suitable computing environment of the method as described in FIGS. 6, 7 and 8 that may be fully or partially implemented. Exemplary computing environment is only one example of a suitable computing environment for the exemplary system of FIG. 1-9 and is not intended to suggest any limitation as to the scope of use or functionality of the systems and methods described herein. Neither should computing environment be interpreted as having any dependency or requirement relating to any one or combination of components illustrated in computing environment.

The methods and systems described herein are operational with numerous other general purpose or special purpose computing system, environments or configurations. Examples of well-known computing systems, environments, and/or configurations that may be suitable for use include, but are not limited to, personal computers, server computers, multiprocessor systems, microprocessor-based systems, network PCs, minicomputers, mainframe computers, distributed computing environments that include any of the above systems or devices, and so on. Compact or subset versions of the framework may also be implemented in clients of limited resources, such as handheld computers, or other computing devices. The invention is practiced in a distributed computing environment where tasks are performed by remote processing devices that are linked through a communications network. In a distributed computing environment, program modules may be located in both local and remote memory storage devices.

With reference to FIG. 10, an exemplary system 1000 of providing assistance to a user to identify at least one context while forming a search query includes a general purpose computing device in the form of a computer implementing, for example, system and/or method of FIG. 1-9. The following described aspects of computer are exemplary implementations of client computing device. Components of computer 1002 may include, but are not limited to, processing unit(s) 1004, a system memory 1006, and a system bus 1008 that couples various system components including the system memory to the processing unit(s) 1004. The system bus 1008 may be any of several types of bus structures including a memory bus or memory controller, a peripheral bus, and a local bus using any of a variety of bus architectures. By way of example and not limitation, such architectures may include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, etc.

A computer 1002 typically includes a variety of computer-readable media. Computer-readable media can be any available media that can be accessed by computer 1002 and includes both volatile and non-volatile media, removable and non-removable media. By way of example, and not limitation, computer-readable media may comprise computer storage media and communication media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1002.

Communication media typically embodies computer-readable instructions, data structures, or program modules, and includes any information delivery media. Combinations of the any of the above should also be included within the scope of computer-readable media.

System memory 1006 includes computer storage media in the form of volatile and/or non-volatile memory such as read only memory (ROM) 1010 and random access memory (RAM). A basic input/output system (BIOS) 1014, containing the basic routines that help to transfer information between elements within computer, such as during start-up, is typically stored in ROM; RAM typically contains data and/or program modules that are immediately accessible to and/or presently being operated on by processing unit. By way of example and not limitation, FIG. 10 illustrates operating system 1032, application programs 1034, other program modules 1036, and program data 1038.

The computer 1002 may also include other removable/non-removable, volatile/non-volatile computer storage media. By way of example only, FIG. 10 illustrates a hard disk 1016 drive that reads from or writes to non-removable, non-volatile magnetic media, a magnetic disk drive 1018 that reads from or writes to a removable, non-volatile magnetic disk 1020, and an optical disk drive 1022 that reads from or writes to a removable, non-volatile optical disk such as a CD ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM, and the like. The hard disk drive 1016 is typically connected to the system bus 1008 through a non-removable memory interface such as interface 1026, and magnetic disk drive 1018 and optical disk drive 1022 are typically connected to the system bus 1008 by a removable memory interface, such as interface 1028.

The drives and their associated computer storage media discussed above and illustrated in FIG. 10, provide storage of computer-readable instructions, data structures, program modules, and other data for the computer 1002. In FIG. 10, for example, hard disk drive 1016 is illustrated as storing operating system 1032, application programs 1034, other program modules 1036, and program data 1038. Note that these components can either be the same as or different from operating system 1032, application programs 1034, other program modules 1036, and program data 1038. Application programs includes, application programs, other program modules, and program data are given different numbers here to illustrate that they are at least different copies.

In one implementation, a user may enter commands and information into the computer 1002 through input devices such as a keyboard 1040 and pointing device 1042, commonly referred to as a mouse, trackball, or touch pad. Other input devices (not shown) may include a microphone, joystick, game pad, satellite dish, scanner, or the like. These and other input devices are often connected to the processing unit 1004 through a user input interface 1044 that is coupled to the system bus, but may be connected by other interface and bus structures, such as a parallel port, game port, 1394/Fire wire, accelerated graphics port, or a universal serial bus (USB).

The computer operates in a networked environment using logical connections to one or more remote computers, such as a remote computer 1002. The remote computer may be a personal computer, a server, a router, a network PC, a mobile computing device, a peer device, or other common network node, and as a function of its particular implementation, may include many or all of the elements described above relative to the computer 1002, although only a memory storage device 1052 has been illustrated in FIG. 10. The logical connections depicted in FIG. 10 include a local area network (LAN) 1054 and a wide area network (WAN) 1056, but may also include other networks. Such networking environments are commonplace in offices, enterprise-wide computer networks, intranets, and the Internet.

When used in a LAN networking environment, the computer 1002 is connected to the LAN 1034 through a network interface or adapter. When used in a WAN networking environment, the computer 1002 typically includes a modem 1060 or other means for establishing communications over the WAN 1056, such as the Internet. The modem 1060, which may be internal or external, may be connected to the system bus 1008 via the user input interface 1044, or other appropriate mechanism. In a networked environment, program modules depicted relative to the computer, or portions thereof, may be stored in the remote memory storage device. By way of example and not limitation, FIG. 10 illustrates remote application programs 1034 as residing on memory device 1052. The network connections shown are exemplary and other means of establishing a communications link between the computers may be used.

The present disclosure may be implemented with a variety of combination of hardware and software. If implemented as a computer-implemented apparatus, the present disclosure is implemented using means for performing all of the steps and functions described above.

The present disclosure can be included in an article of manufacture (e.g., one or more computer program products) having, for instance, computer usable media. The media has embodied therein, for instance, computer readable program code means for providing and facilitating the mechanisms of the present invention. The article of manufacture can be included as part of a computer system or sold separately.

FIGS. 1-10 are merely representational and are not drawn to scale. Certain portions thereof may be exaggerated, while others may be minimized. FIGS. 1-10 illustrate various embodiments of the disclosed invention that can be understood and appropriately carried out by those of ordinary skill in the art.

In the foregoing detailed description of embodiments of the invention, various features are grouped together in a single embodiment for the purpose of streamlining the disclosure.

The present invention as described above helps the user by providing more details of the search results to select the most appropriate result from the list of results. The search results provided by the system have more details about the content of each result in addition to providing the relationship among the results. In addition, the present invention helps the user in summarizing the content of each retrieved document. Also, the present invention provides a graphical user interface for the user to easily navigate through the results and select the most relevant document from the results.

We claim:

1. A method of providing assistance to a user to identify at least one context of search results of a search query, the method comprising:
receiving an input related to the search query;
providing a plurality of first contexts related to the received input, wherein the first contexts include one of the keywords and concepts;
displaying a set of results from a web search or a file search based on the selection of the first context, each search result containing a link to a web page or file location; and
displaying a plurality of second contexts relevant to the search results, wherein the second contexts include one or more topics, and wherein the topics are part of one or more ontologies.

2. A method of providing assistance to a user to identify at least one context of a received content as input, the method comprising:
receiving at least one content location as input from the user;
extracting the content from the received content location; and
displaying a plurality of contexts relevant to the content from the received content location, wherein the contexts include one or more topics, and wherein the topics are part of one or more ontologies.

3. The method of claim 2, wherein the content location includes a link to a file or a webpage containing the content.

4. The method of claim 2, wherein the content location includes a folder containing a content location.

5. A method of providing assistance to a user to identify at least one context of search results of a search query, the method comprising:
receiving an input as a search query;
displaying a set of results from a web search or a file search, each search result containing a link to a web page or file location; and
displaying a plurality of contexts relevant to the search results, wherein the contexts include one or more topics, and wherein the topics are part of one or more ontologies.

6. The method of claim 5, wherein the input includes at least one term, document, or Uniform Resource Locator (URL).

7. The method of claim 5, further comprising:
displaying a graphical relation between parts of one or more ontologies related to one or more topics.

8. The method of claim 5, further comprising:
generating a list of keywords/concepts related to the search results.

9. The method of claim 5, wherein the displaying a plurality of contexts is based on the relevance ranking that matches the search results.

10. The method of claim 5, wherein displaying a part of one or more ontologies related to one or more of the contexts are in a two-dimensional or three-dimensional representation.

11. The method of claim 5, wherein one or more ontologies includes a plurality of assertions with each assertions comprising a first topic, a second topic and a relationship between the first topic and the second topic.

12. The method of claim 7, wherein displaying a graphical relation between parts of one or more ontologies related to one or more of the topics in a graphical region includes:
a root node that depicts at least one topic; and
a plurality of sets of connected nodes, each connected node corresponding to at least one topic, wherein each connected node is connected to the root node, each of the connections corresponding to at least one relationship.

13. The method of claim 12, further comprising:
allowing the user to navigate in the graphical region, wherein the navigation includes a first selection of any node that retrieves a part of ontology related to the first selected node and the first selected node becomes the root node.

14. The method of claim 13, wherein the step of allowing the user to navigate in the graphical region further includes a second selection of any node that retrieves a set of documents related to the second selected node and displays in terms of web page URL or file location.

15. The method of claim 5, wherein one or more ontologies includes a plurality of assertions with each assertion comprising a first topic, a second topic and a relationship between the first topic and the second topic.

16. A system of providing assistance to a user to identify one or more contexts of the search results of a search query, the system comprising:
one or more communication networks;
a plurality of user devices connected to the communication network; and
at least one server coupled to a data store, the server comprising a content extractor and a context module, wherein the server is capable of communicating with the plurality of user devices via at least one communication network, the server is configured for
receiving an input as a search query;
displaying a set of search results from a web search or a file search, each search result containing a link to a web page or file location; and
displaying a plurality of contexts related to the search results, wherein the contexts include one or more topics, and wherein the topics are part of one or more ontologies.

17. The system of claim 16, wherein the input includes at least one term, document, or Uniform Resource Locator (URL).

18. The system of claim 16, further the server is configured for
displaying a plurality of topics relevant to the search results, wherein the topics are displayed based on the relevance ranking that matches the search results.

19. The system of claim 16, further the server is configured for
displaying a graphical relation between parts of one or more ontologies related to one or more of the topics.

20. The system of claim 16, further the server is configured for
generating a list of keywords related to the search results.

21. The system of claim 16, wherein the data store comprising:
a domain thesauri; and
a domain ontology

22. The system of claim 16, wherein the content extractor is capable of extracting the content from the received input, wherein the input is in the form of queries, documents or URLs.

23. The system of claim 16, wherein the context module includes a keyword module, a concept module and an ontology module, and wherein the context module coupled to the content extractor and data store for processing the received input from the content extractor provides or generates keyword list, concept list, topics and their relations.

24. A machine-readable medium having stored thereon machine-executable instructions that if executed by a machine cause the machine to perform the method of providing assistance to a user to identify at least one context of search results of a search query, the method comprising:
receiving an input as a search query;
displaying a set of results from a web search or a file search, each search result containing a link to a web page or file location; and
displaying a plurality of contexts relevant to the search results, wherein the contexts include one or more topics, and wherein the topics are part of one or more ontologies.

25. The machine-readable medium of claim 24, wherein the input includes at least one term, document, or Uniform Resource Locator (URL).
